(19) United States
(12) Patent Application Publication
(10) Pub. No.: US 2015/0049401 A1
(43) Pub. Date: Feb. 19, 2015

(54) PERPENDICULAR TIMING-BASED SERVO HEADS

(71) Applicant: Matthew P. Dugas, North Oaks, MN (US)

(72) Inventor: Matthew P. Dugas, North Oaks, MN (US)

(21) Appl. No.: 13/316,270

(22) Filed: Dec. 9, 2011

Related U.S. Application Data
(60) Provisional application No. 61/421,378, filed on Dec. 9, 2010.

(51) Int. Cl. G11B 5/127; G11B 20/12; G11B 5/187

(52) U.S. Cl. CPC G11B 5/1278; G11B 5/187; G11B 20/1217
USPC 360/125.02

(57) ABSTRACT

A perpendicular recording head and tape having some perpendicular component of magnetization are provided. The perpendicular recording head may contain at least two non-parallel poles such that each set of such poles may form the writing poles for recording a timing based servo band onto the tape medium.

### BACKGROUND OF THE INVENTION

Longitudinal Magnetic Recording (LMR) and Perpendicular Magnetic Recording (PMR) generally refer to the ability of a recording medium to support in-plane (e.g., LMR) and out-of-plane (e.g., PMR) modes of magnetization. This ability can largely be determined by the physics of the magnetic materials.

PMR materials have been long studied for their potentially many fundamental advantages over LMR materials at ever higher bit densities. However, the well-established recording technology of LMR decreased the media thickness, increased the media coercivity, and made other incremental improvements that kept PMR developments generally at bay. Indeed, for more than 25 years after the introduction of PMR in research and development circles, LMR continued its dominance in the commercial marketplace.

Nonetheless, LMR has begun to run into the wall of fundamental physics and incremental evolution, and PMR has now taken over the technology in rigid disk drives, also referred to as hard disk drives (HDD). HDD have always pushed the limits of magnetic recording in terms of linear bit density and track density because of the mechanical stability of a rigid or hard disk medium as compared to that of flexible media, such as floppy and tape media.

Flexible media, such as magnetic tape, however, has lower bit areal density due to a less precise surface and thermal and hygroscopic expansion factors, among other factors. Yet, because of its flexibility, tape has other advantages, such as high volumetric density, a cartridge based design, and extremely high data capacity when used in automated data storage libraries. In short, tape data storage continues to play a dominant role in archival data storage as a result of many of its attributes in that sector of the data storage hierarchy.

The need for tape to “go perpendicular” commercially has not yet fully arisen. But, if the direction of technology for tape continues to increasing its areal and volumetric density by increasing bit density, some form of perpendicular tape media may eventually be desirable. However, there are many challenges to making such a perpendicular mode of magnetization in a commercially viable tape medium. While not an absolute requirement, one of the challenges may be to make a PMR tape medium with a soft magnetic under layer, also called double layer perpendicular medium or a keeper layer. Such an under layer can make the PMR system more efficient and assist the write head in recording on the PMR medium. However, many do not foresee this happening, as this is best done with physical vapor deposition, which will be an expensive process for tape manufactures; furthermore, such thin film tape has other potential technological risks. Instead, current tape manufacture is largely a magnetic particle pigment wet coating process which is very cheap and economical.

Of conventional head designs for PMR, the most common are sometimes called single-pole heads, or main pole driven heads. Main pole driven heads work better with double layer media, but longitudinal heads, also known as “ring heads” can also be used with success in PMR single layer media. Single-pole perpendicular heads and longitudinal ring heads both have horizontal and vertical components of magnetization, i.e., longitudinal and perpendicular components of magnetization.

Still, there is a need in the art for PMR magnetic recording heads for flexible media. Additionally, there is a need in the art for PMR timing based magnetic recording heads for flexible media. Further yet, there is a need in the art for a method of formatting flexible media using a PMR magnetic recording head and a flexible media, or tape, made thereby. Particularly, there exist a need in the art to make a tape medium which has perpendicular transitions forming a timing based servo pattern.

### BRIEF SUMMARY OF THE INVENTION

A combination to be used in evolving tape systems may initially be that of advanced longitudinal heads in combination with a medium that has a relatively large perpendicular magnetization component, such as Barium Ferrite based magnetic particle. This will initially not have a soft magnetic under layer, and therefore, advanced longitudinal heads may be a desirable choice for initial systems.

In tape based systems, all recording heads currently use LMR media. Time based heads require at least two non-parallel writing gaps and hence must be made from a different sequence of processing steps from those from which conventional write heads are made. This is true whether the head construction is made from a composite ferrite-ceramic substrate, a ferrite substrate, or the non-magnetic substrates of a pure integrated thin film head. The at-least-two non-parallel gaps requirement of a timing based recording (write) head is of a unique gap construction no matter what basic substrate is used to build the gap layer thereupon.

A pure perpendicular timing based format head may also contain at least two non-parallel writing poles for recording time based formats and may be made using a different sequence of processing steps from those from which conventional write heads are made. The at-least-two non-parallel write poles requirement of a timing base recording (write) head is of a unique write pole construction.

The disclosure is related to both perpendicular timing based servo written tape media and perpendicular servo recording heads having at least two write poles, which are non-parallel to one another and have a precision spatial relationship, and can record two perpendicular magnetic transitions substantially simultaneously on a tape medium. The present disclosure describes, for example, various embodiments of a double pole perpendicular head, and more specifically that having at least two write poles which are non-parallel such that they record two perpendicular magnetic mode transitions on a tape medium which is a timing based servo format.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 is a cross-sectional view of a perpendicular recording head according to one embodiment of the present disclosure.

FIG. 2 is a top view of a perpendicular recording head according to one embodiment of the present disclosure.

FIG. 3 is a top view of a perpendicular recording head according to another embodiment of the present disclosure.

FIG. 4 is a cross-sectional view of a perpendicular recording head according to yet another embodiment of the present disclosure.

FIG. 5 is a cross-sectional view of a perpendicular recording head according to still a further embodiment of the present disclosure.

FIG. 6a is a cross-sectional view of a perpendicular recording medium showing the magnetized regions of the servo track in schematic form.

FIG. 6b is a schematic illustration of current pulses that produced the magnetization pattern of 6a.

FIG. 7a is a top schematic view of a magnetic recording medium showing two perpendicular timing based servo bands and the data band inbetween the two servo bands.

FIG. 7b is a close-up view of the magnetization of one magnetization mark of a servo band of FIG. 7a.

### DESCRIPTION OF THE DISCLOSURE

In various embodiments a magnetic head may be a composite structure based on ferrite, thin film, and non-magnetic ceramic materials, but in other embodiments, fully integrated thin film structures may be used and are considered within the scope of the present disclosure.

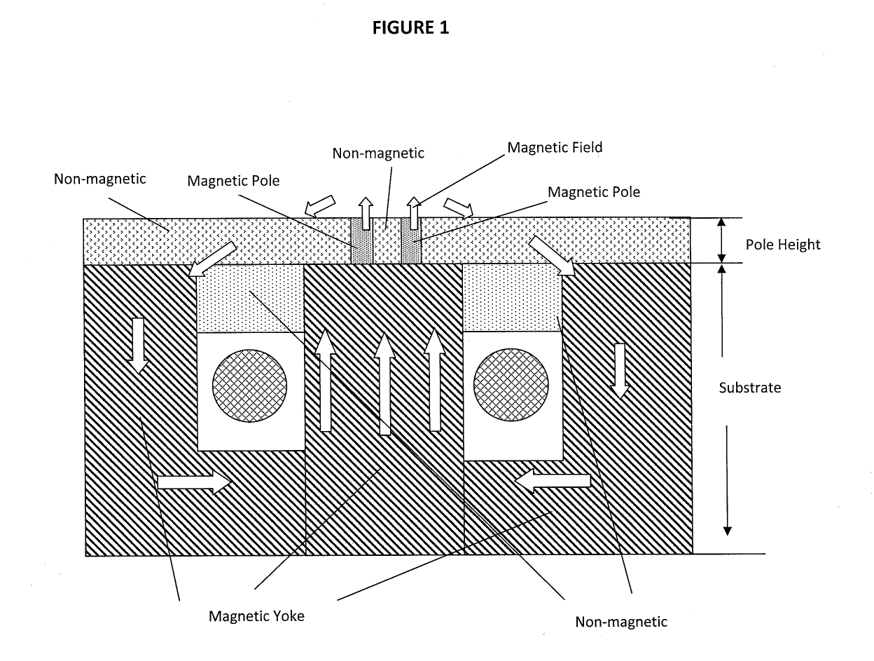

FIG. 1 illustrates a side cross-sectional view of one embodiment of the head of the present disclosure. The wide arrows represent the magnetic field in a schematic fashion for a given direction of the current through the coil shown. Although not required, as shown in this embodiment, the head has flux return yokes to either side of the main pole yoke. A coil is wound on the main pole yoke and energizes the two main poles of the head. However, the coil may be on the main pole side of the head, may be on the opposite side of the head, or may be on both sides of the head.

In general, as shown in FIG. 1, a relatively soft magnetic material may make part of a substrate material. The soft magnetic material may be made atop a relatively large magnetic yoke structure. Two magnetic write poles may be grown onto, plated up, or etched from the magnetic yoke. All such variations of the processing are possible. For purposes of mechanical stability, in some embodiments, the magnetic poles may be encapsulated with a substantially non-magnetic material, and the structure can be planarized so the poles can engage a magnetic medium passing by the poles. This supporting layer, made of the substantially non-magnetic material, may also serve as a tape bearing surface. The magnetic yoke structure may be driven by a coil. The coil could be hand wound or could be a thin film coil. The coil may drive the yoke in the direction shown for a given polarity of the current, and in turn, the magnetic write poles may be energized. In the embodiment shown in FIG. 1, the flux path may be closed, thereby making a more efficient head.

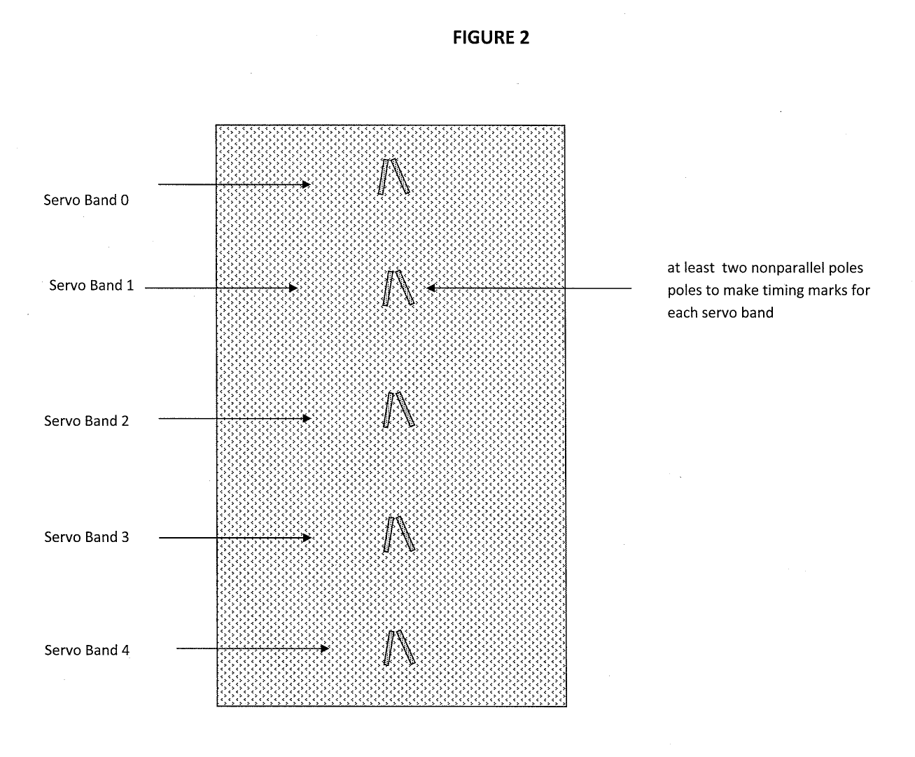

As illustrated in FIG. 2, each set of at least two poles shown can record the magnetic marks of the poles, the at least two poles being non-parallel and able to make perpendicular timing marks onto the perpendicular tape medium. In one embodiment, all sets of poles may be energized by a common yoke and coil, and therefore all sets of poles are written at the same time and with the same information.

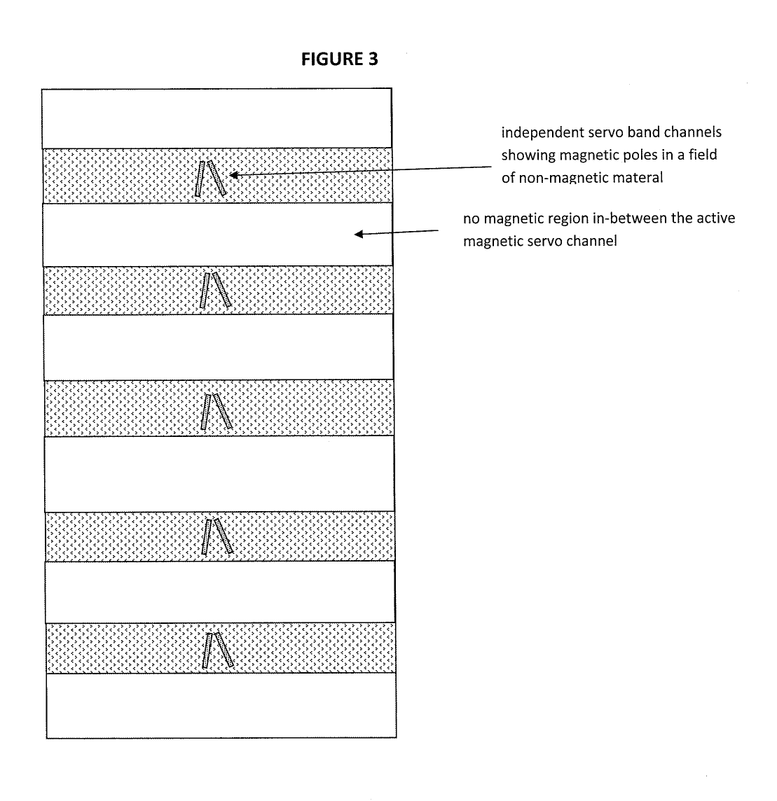

In further embodiments, in a similar fashion to that of U.S. Pat. No. 6,496,328, which is hereby incorporated by reference herein in its entirety, a true multi-channel PMR head can be made with more complex manufacturing techniques. One embodiment of such a true multi-channel PMR head is illustrated in FIG. 3. FIG. 3 shows a surface view of the another head which includes independent channels with, for example, one channel per servo band. Each set of at least two poles shown can record the magnetic marks of the poles, the at least two poles being non-parallel and able to make perpendicular timing marks onto the perpendicular tape medium; in this case, each channel may record a timing based servo channel with either the exact same information or with different information, as desired. They may record different information if the channels are independently driven, and have a unique coil for each uniquely driven channel or set of channels which are independently driven. The different information being written into each channel may contain servo information in combination with unique servo band and/or data band identification information; however, other information as desired may be recorded into the servo band. Each channel may record a servo band independently in one embodiment of the disclosure. In one embodiment, the write current of one channel may be configured so as to not affect or cross talk with another channel in a significant manner; sufficient separation is given so that different servo information may be encoded into each channel if desired.

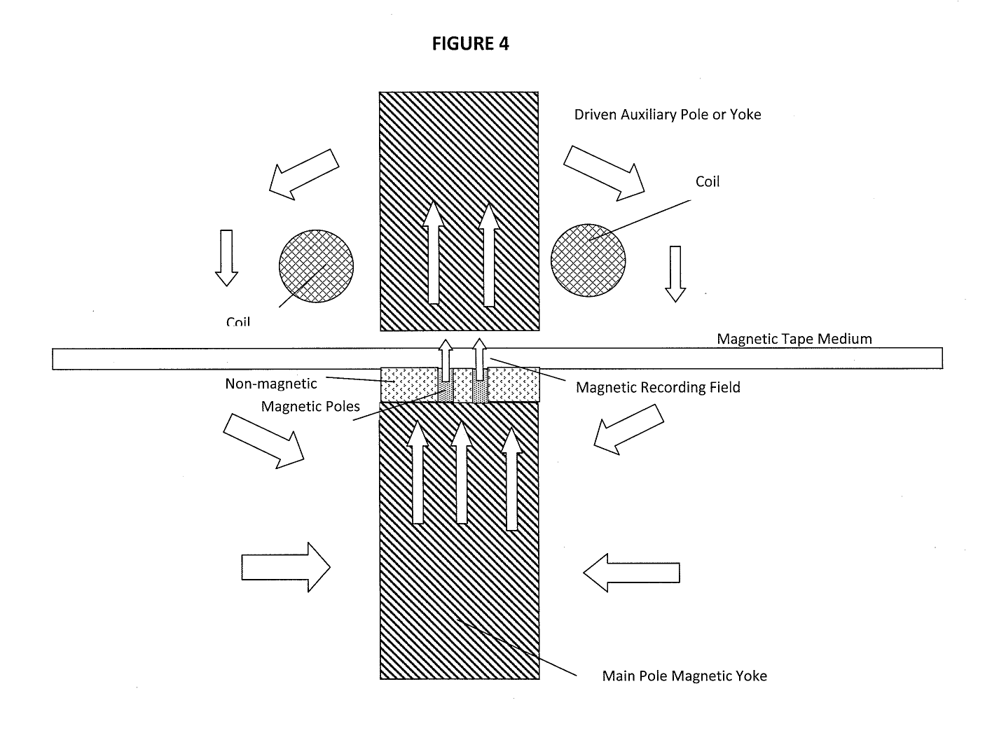

FIG. 4 shows a side view of an auxiliary pole driven head according to another embodiment of the present disclosure. Such a head may have a good ability to generate a deep recording field through a single layer recording medium. While the head is shown schematically, those skilled in the art will appreciate that more efficiency may be had with the use of flux return yokes on the main pole side, the auxiliary pole side, or both. Hence the schematic of the head embodiment shown in FIG. 4 should not be considered limiting.

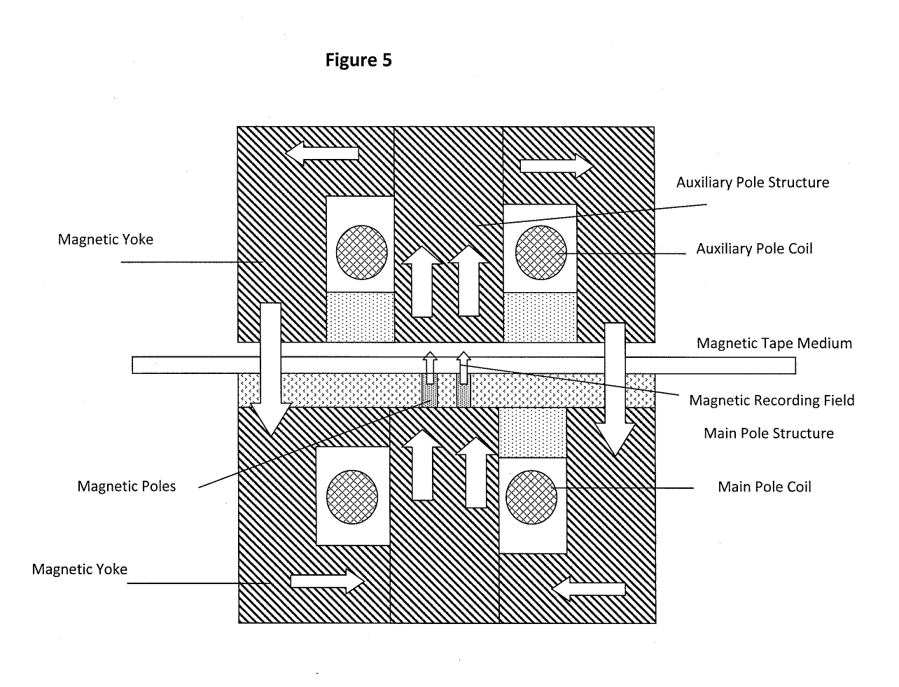

FIG. 5 shows a side view of another embodiment of a perpendicular head that may be driven from both sides of the magnetic tape medium. Such a head may have a good ability to generate a deep recording field through a single layer perpendicular recording medium. While the head is shown schematically, those skilled in the art will appreciate that various ways to drive the head may be used, such as, for example, driving just the auxiliary side, driving just the main pole side, or driving both sides. Hence the schematic of the head embodiment shown in FIG. 5 should not be considered limiting.

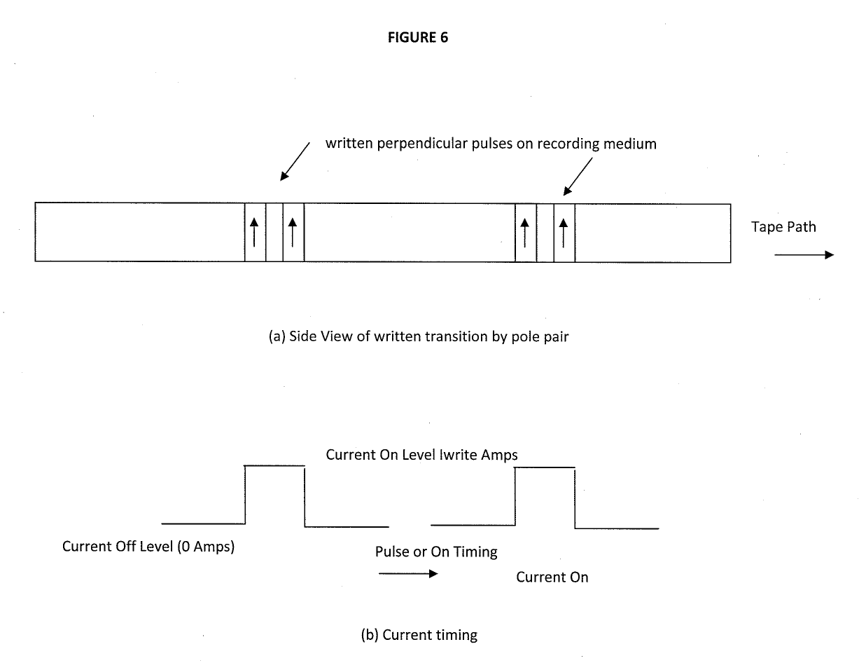

A side view of the recording medium is shown in FIG. 6a with the associated write current pulse shown in FIG. 6b. The magnetization is shown in the “up” or perpendicular polarity in an idealized schematic manner.

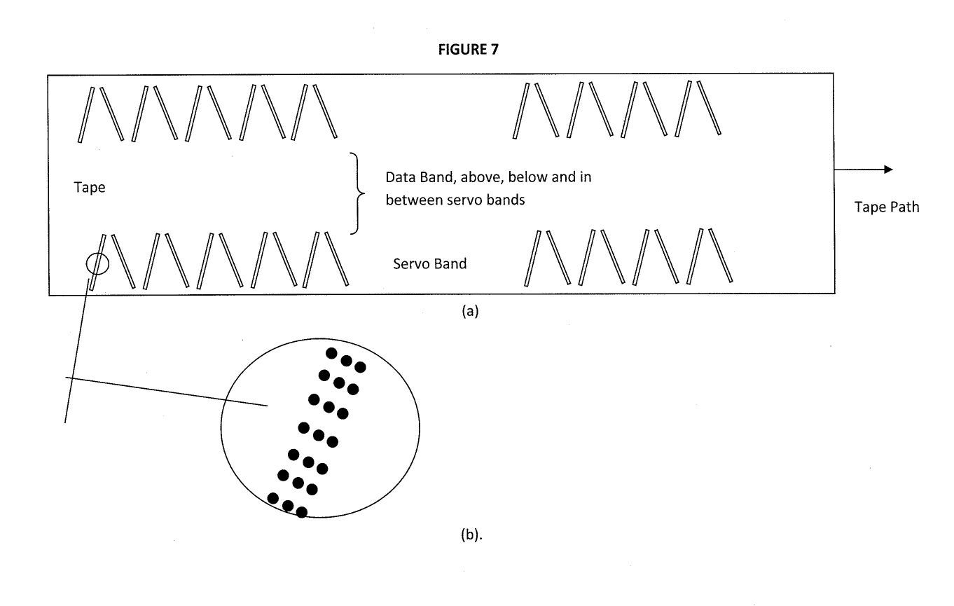

A surface or top view of two servo bands in shown in FIG. 7a with a close up of one poles' magnetization being shown in FIG. 7b. The top view of the tape surface shows one track of the perpendicular time based servo signal, with pulse repeats in a five pulse and then a four pulse waver train, with a space inbetween. This is similar to LTO formatted tape. The polarity is again shown as “up” bits, with the servo tracks being magnetized up or perpendicularly.

FIG. 7b shows a close up of a section of one recorded pulse of one pole of a set of two poles. The “up” polarity is shown in the usual vector notation, a dot for magnetization out of the plane shown. The polarity can be up or down and can also be bi-polar.

In additional embodiments, applications involving magnetic flux sourcing from one of the two pole and magnetic flux sinking or returning into the other of the pole pairs is considered within the scope of the disclosure. In the latter embodiment, the magnetic yoke could be different such that the flux would leave one of the poles of the pole pair and return into the other of the pole pairs.

In general, described herein are various embodiments of a perpendicular recording head that is capable of recording timing based format patterns on perpendicular tape media. The head may be made on a substrate structure that contains a driving yoke. A thin film may be deposited on the substrate structure, and pole features can be pattered and etched therein. Alternatively, the thin film may be plated up into pole patterns. The pole patterns may include at least two non-parallel writing poles, and thus, can record perpendicular timing based mark pairs in the flexible medium. In one embodiment, the head can be made with a single channel, while in other embodiments, the head may include two or more true independently driven channels. In some embodiments, the head can be made using thin film techniques made upon a composite substrate. In still other embodiments, the head can be made using pure thin film techniques or hybrid variations of techniques. The head construction can result in a pair of poles that can record perpendicular transitions on a recording medium capable of supporting perpendicular transitions. That is, perpendicular tape media can be formatted by the various embodiments of recording heads disclosed herein.

Similarly, drives and other systems using perpendicular tape media with time based servo will be enabled by the various embodiments of heads disclosed herein. The various embodiments disclosed herein may be used to format media with arbitrary transition patterns, using arbitrary pole patterns. In still further embodiments, while discussed mainly with respect to timing based servo, the various embodiments of heads disclosed herein may be used to record time based servo, amplitude based servo, high angle azimuthal servo signals, and/or any other recording signal that can uniquely be made by the heads of this disclosure.

The various embodiments of the present disclosure may be made using any suitable manufacturing techniques. For example, the general structures of the various embodiments of heads as described in the present disclosure may be made generally similar to or made in accordance with the magnetic recording heads and methods of making the same as described in U.S. Pat. No. 6,269,533, titled “Method of Making a Patterned Magnetic Recording Head,” U.S. Pat. No. 7,386,934, titled “Double Layer Patterning and Technique for Milling Patterns for a Servo Recording Head,” U.S. Pat. No. 7,196,870, titled “Patterned Magnetic Recording Head with Termination Pattern Having a Curved Portion,” U.S. Pat. No. 6,496,328, titled “Low Inductance, Ferrite Sub-gap Substrate Structure for Surface Film Magnetic Recording Heads,” U.S. Pat. No. 6,989,960, titled “Wear Pads for Timing-based Surface Film Servo Heads,” U.S. Pat. No. 7,450,341, titled “Integrated Thin Film Subgap Subpole Structure for Arbitrary Gap Pattern Magnetic Recording Heads and Method of Making the Same,” U.S. Pat. No. 7,283,317, titled “Apparatuses and Methods for Pre-Erasing During Manufacture of Magnetic Tape,” U.S. Pat. No. 7,511,907, titled “Stepped Time Based Servo Pattern and Head,” U.S. Pat. No. 7,301,716, titled “Stepped Time Based Servo Pattern and Head,” U.S. Pat. No. 6,947,247, titled “Large Angle Azimuth Recording and Head Configurations,” U.S. Pat. No. 7,106,544, titled “Servo Systems, Servo Heads, Servo Patterns for Data Storage Especially for Reading, Writing, and Recording in Magnetic Recording Tape,” U.S. application Ser. No. 11/017,529, titled “Timing-based Servo Verify Head and Method Thereof,” filed Dec. 20, 2004, U.S. application Ser. No. 11/061,253, titled “Magnetic Recording Head Having Secondary Sub-gaps,” filed Feb. 18, 2005, U.S. application Ser. No. 12/414,604, titled “Thin Film Planar Arbitrary Gap Pattern Magnetic Head,” filed Mar. 30, 2009, PCT Appl. No. PCT/US09/31798, titled “Recording Heads with Embedded Tape Guides and Magnetic Media Made by Such Recording Heads,” filed on Jan. 23, 2009, and U.S. application Ser. No. 12/539,539, titled “Method for Bipolar Trailing Edge Timing-Based Servo Track Recording and Magnetic Tape Made Therewith,” filed on Aug. 11, 2009, each of which is hereby incorporated by reference herein in its entirety.

In the foregoing description, various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A perpendicular recording head containing at least two non-parallel writing poles that are simultaneously energized.

2. The perpendicular recording head of claim 1 wherein the at least two non-parallel writing poles comprise a timing based servo pattern.

3. The perpendicular recording head of claim 1 comprising a substrate including a magnetic yoke, the at least two non-parallel writing poles formed on the magnetic yoke.

4. The perpendicular recording head of claim 3, further comprising a substantially non-magnetic thin film layer surrounding the at least two non-parallel writing poles.

5. A flexible perpendicular recording medium that contains a timing based servo format.

6. A method of formatting a flexible medium using a perpendicular recording head containing at least two non-parallel writing poles that are simultaneously energized.
